(19) United States
(12) Patent Application Publication
(10) Pub. No.: US 2010/0079904 A1
(43) Pub. Date: Apr. 1, 2010

(54) STORAGE CONTROL METHOD, STORAGE CONTROL UNIT AND STORAGE APPARATUS

(75) Inventor: Noriyuki Sato, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/501,103

(22) Filed: Jul. 10, 2009

(30) Foreign Application Priority Data
Sep. 29, 2008 (JP) 2008-249619

(51) Int. Cl. G11B 5/596

(52) U.S. Cl. 360/77.08; G9B/5.216

(57) ABSTRACT

A control method includes determining whether a size of write data specified by a command supplied from a host is smaller than a size of a physical sector of a recording medium, lowering priority of the write data when the size of the write data is smaller than the size of the physical sector, continuously reading, when a plurality of commands for write data having lowered priority are supplied, data in physical sectors specified in the plurality of commands, and executing a modify write process on the basis of a result of continuously reading the data.

### CROSS-REFERENCE TO RELATED APPLICATION

This application is based upon and claims the benefit of priority of the prior Japanese Patent Application No. 2008-249619, filed on Sep. 29, 2008, the entire contents of which are incorporated herein by reference.

### FIELD

A certain aspect of the embodiments described herein is related to a storage control method, a storage control unit, and a storage apparatus.

### BACKGROUND

Recently, there has been a considerable activity in increasing the storage capacity of hard disk drives. A disk format having a high format efficiency called large sector has been proposed as means for realizing the large capacity.

According to the large sector format, one sector of the magnetic disk drives has a size greater than a conventional size of 512 bytes, which may be 1024 bytes or 4096 bytes. When the large sector format is employed, a host computer that controls the magnetic disk drives may not deal with the large sector format. In order to cope with this problem, an emulation using read modify write (RMW) may be executed for data requested to be written in a unit of 512 bytes (see Japanese Laid-Open Patent Publication No. 2002-15507).

The emulation operation using the read modify write has a sequence of reading data from a sector on a recording medium to store the data in a buffer, overwriting data in sectors requested by the host computer on the 512-byte base to thus modify the data with the read data, and writing the overwritten data in the original sectors on the recording medium. Thus, each command needs the time for reading and modifying. This degrades the performance of the magnetic disk drive, and more particularly, decreases the write speed.

### SUMMARY

According to an aspect of the present invention, there is provided a control method including: determining whether a size of write data specified by a command supplied from a host is smaller than a size of a physical sector of a recording medium; lowering priority of the write data when the size of the write data is smaller than the size of the physical sector; continuously reading, when a plurality of commands for write data having lowered priority are supplied, data in physical sectors specified in the plurality of commands; and executing a modify write process on the basis of a result of continuously reading the data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of a magnetic disk drive in accordance with a first embodiment;

FIG. 2 is a functional block diagram of a buffer memory controller illustrated in FIG. 1;

FIG. 3 is a flowchart of a process of the first embodiment;

FIGS. 4A through 4D illustrate an example of a read modify write process;

FIG. 5 is a flowchart of a comparative example;

FIGS. 6A through 6C illustrate an exemplary process of the comparative example;

FIG. 7 is a functional block diagram of a buffer memory controller employed in a second embodiment;

FIG. 8 is a flowchart of a process of queuing a command in a command queue in accordance with the second embodiment;

FIG. 9 is a flowchart of a write process in accordance with the second embodiment;

FIG. 10 illustrates a process of the second embodiment;

FIG. 11 is a functional block diagram of a buffer memory controller employed in a third embodiment;

FIG. 12 is a flowchart of a process of the third embodiment;

FIGS. 13A and 13B illustrate a process of the third embodiment;

FIG. 14 is a flowchart of a fourth embodiment;

FIG. 15 is a functional block diagram of a buffer memory controller employed in a fifth embodiment;

FIG. 16 is a flowchart of a process of queuing a command in accordance with the fifth embodiment;

FIG. 17 illustrates an exemplary command queue obtained by the process illustrated in FIG. 16; and

FIG. 18 is a flowchart of a process for requesting a host computer to send write data by using a command queue in accordance with the fifth embodiment.

### DESCRIPTION OF EMBODIMENTS

### First Embodiment

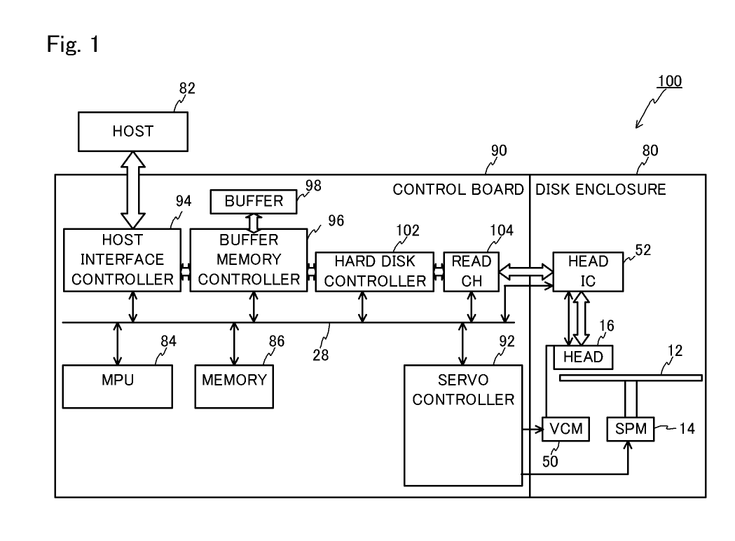

A description will now be given of a magnetic disk drive in accordance with a first embodiment with reference to FIGS. 1 through 4D.

FIG. 1 is a block diagram of a magnetic disk drive 100 in accordance with the first embodiment. Referring to FIG. 1, the magnetic disk drive 100 includes a disk enclosure 80 and a control board 90.

The disk enclosure 80 has a spindle motor (SPM) 14, a voice coil motor (VCM) 50, a head 16, and a head IC 52. The spindle motor 14 rotates a magnetic disk 12 at a revolution as high as 4200 to 15000 rpm. The magnetic disk 12 employs the large sector format capable of realizing a high format efficiency in order to secure a large storage capacity. More specifically, the magnetic disk 12 has a physical sector having a size greater than a conventional size of 512 bytes, and may, for example, be 4096 bytes. The voice coil motor 50 drives a head stack assembly (not illustrated), which holds the head 16 to change the relative positional relation between the head 16 and the magnetic disk 12. The head 16 includes a main body made of ceramic in which a write element and a read element are incorporated. The write element includes a write coil and a write core. The read element is arranged adjacent to the write core. The read element may, for example, be a GMR (Giant Magneto Resistance) element or a TMR (Tunneling Magneto Resistance) element. The head IC 52 selects one of heads based on a write command or a read command supplied from a host computer 82, and performs a write or read operation on the magnetic disk 12. In FIG. 1, only one magnetic head 16 and only one magnetic disk 12 are illustrated for the sake of convenience. The head IC 52 includes a write amplifier in a write system and a pre-amplifier in a read system.

The control board 90 includes a MPU (Micro Processing Unit) 84, a memory 86, a servo controller 92, a host interface controller 94, a buffer memory controller 96, a buffer memory 98, a hard disk controller 102, and a read channel 104. These structural elements are connected to a bus 28.

The memory 86 may include a volatile memory and a non-volatile memory. The volatile memory may temporarily store a table in which various parameters are stored. The non-volatile memory may store initial data. The servo controller 92 drives and controls the voice coil motor 50 and the spindle motor 14.

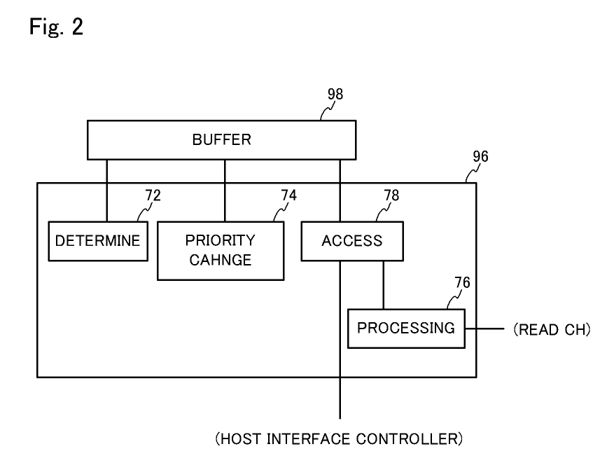

The buffer memory controller 96 controls a read/write operation on the buffer memory 98. As illustrated in FIG. 2, the buffer memory controller 96 is equipped with a determining part 72, an order changing part 74, a processing part 76, and an accessing part 78.

The determining part 72 performs various determinations. For example, the determining part 72 determines whether the size of write data supplied from the host compute 82 and stored in the buffer memory 98 is smaller than the physical sector of the magnetic disk 12 (equal to 4096 bytes). The order changing part 74 lowers the priority of data that is determined by the determining part 72 to have a size smaller than the physical sector of the magnetic disk 12. In practice, the priority of command may be lowered. The processing part 76 executes an emulation operation using a read modify write process. The accessing part 78 stores data supplied from the host computer 82 in the buffer memory 98 and reads data therefrom.

Turning back to FIG. 1, the read channel 104 functions as a write modulator and a read demodulator.

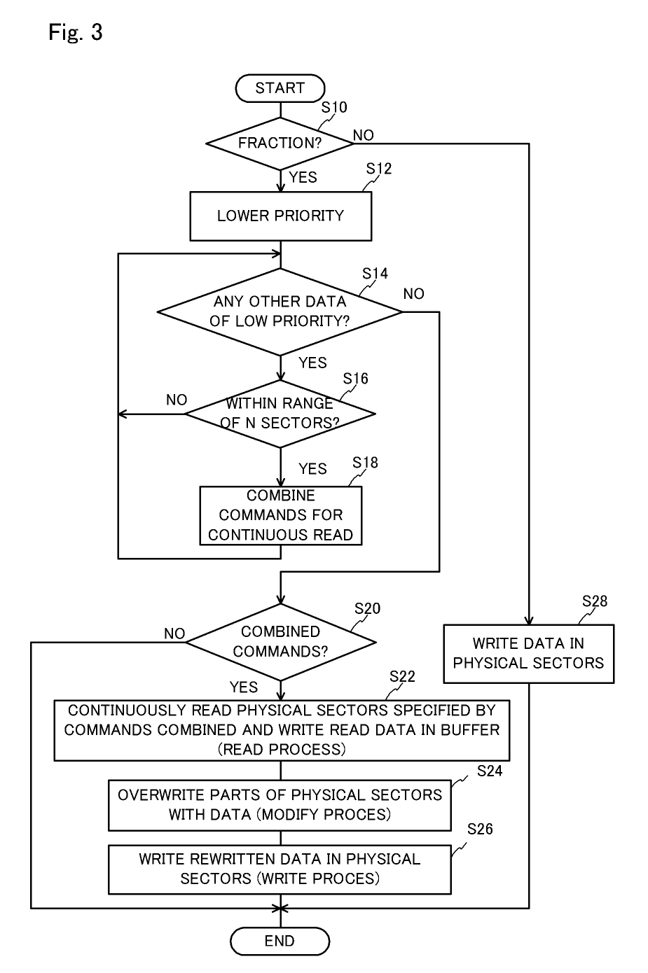

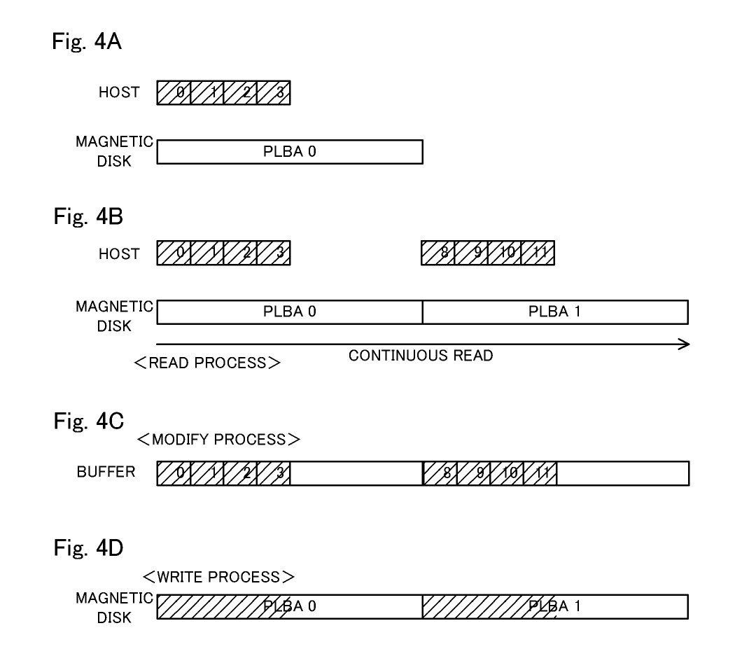

The magnetic disk drive 100 operates as described in FIGS. 3 and 4A through 4D. The operation of the magnetic disk drive 100 illustrated in FIGS. 3 and 4 through 4D is controlled mainly by the buffer memory controller 96.

The host computer 82 issues a write request (command) to the magnetic disk drive 100. The host interface controller 94 creates a command management table used to manage the write request issued by the host computer 82, and registers the created command management table in the buffer memory 98. The buffer memory controller 96 confirms the command management table and checks whether a free area is available in the buffer memory 98. Then, the buffer memory controller 96 requests the host computer 82 to send write data. The buffer memory controller 96 receives write data from the host computer 82 and stores the received write data in the buffer memory 98. At this stage, the process illustrated in FIG. 3 is initiated. When the write data is stored in the buffer memory 98, the host interface controller 94 registers cache information on the write data stored in the buffer memory 98 in the memory 86 or the buffer memory 98. The MPU 84 may be involved in storing the write data and registering the cache information.

At step S10 depicted in FIG. 3, the determining part 72 of the buffer memory controller 96 compares the size of the write data stored in the buffer memory 98 with the size of the physical sector, and determines whether there is a fraction or remainder, that is, whether the size of the write data from the host computer 82 is smaller than that of the physical sector 4096 bytes) of the magnetic disk 12. For example, as illustrated in FIG. 4A, the answer of step S10 is YES when data (LBA0-LBA3: 2048 bytes) supplied from the host computer 82 is smaller than a physical sector PLBA0 (4096 bytes) of the magnetic disk 12.

When the answer of step S10 is YES, the process proceeds to step S12 at which the order changing part 74 lowers the priority of the data (the command corresponding to the data) supplied from the host computer 82.

At step S14, the determining part 72 determines whether there is another command of a low priority in the buffer memory 98. For example, as illustrated in FIG. 4B, if data LBA8-LBA11 of a low priority (having a fraction with regard to a physical sector PLBA1) are in the buffer memory 98, the answer of step S14 is YES.

When the answer of step S14 is YES, the process proceeds to step S16 depicted in FIG. 3. At step S16, the determining part 72 determines whether the physical sectors PLBA0 and PLBA1 specified in the commands of the low priority are located within the range of N sectors where N is a predetermined natural number. The range of N sectors is a reference used to determine whether the physical sectors are located within a certain close range, and N is appropriately selected in the design stage. When the answer of step S16 is YES, the process proceeds to step S18 at which the processing part 76 combines the commands so that the read process in the read modify write process can be executed over the commands continuously.

In contrast, when the answer of sep S16 is NO, that is, when the physical sectors are located away from each other, the process returns to step S14 without combining the commands.

The determination of step S16 (and the process of step S18) is repeatedly carried out as long as data (command) designed to have the low priority remains in the buffer memory 98. When all of data (commands) assigned the low priority have been determined and processed, the answer of step S14 is NO, and the process proceeds to step S20. If there are three items of data having the low priority or more within the range of N sectors, three or more commands are combined. In the following description, as illustrated in FIG. 4B, it is assumed that data LBA0-LBA3 and data LBA8-LBA11 are recorded in physical sectors within the range of N sectors, and only the two related commands are combined.

At step S20, the processing part 76 determines whether there are commands combined at step S18. When the answer of step S20 is NO, the process is terminated. In contrast, when the answer of step S20 is YES, the process proceeds to step S22.

At step S22, the processing part 76 reads the physical sectors specified in the combined commands (see the lower part of FIG. 4B) continuously by using the read channel 104, the head IC 52 and the head 16, and stores the read data in the buffer. The above read process is the read process in the read modify write process.

At step S24, the processing part 76 modifies part of the data read from the physical sectors with data stored in the buffer, as illustrated in FIG. 4C. This process is the modify process in the read modify write process.

At step S26, as illustrated in FIG. 4D, the processing part 76 writes the data (4096 bytes) obtained by the modify process in the magnetic disk 12 by using the read channel 104, the head IC 52 and the head 16. This process is the write process in the read modify write process.

When it is determined at step S10 that the data do not have any fraction, that is when it is determined that the size of the data supplied from the host computer 82 is equal to that of the physical sector (4096 bytes) of the magnetic disk 12, the answer of step S10 is NO, and the process proceeds to step S28. In this case, there is no data that needs the read modify write process. Thus, the data is written in the magnetic disk 12 by using the read channel 104, the head IC 52 and the head 16.

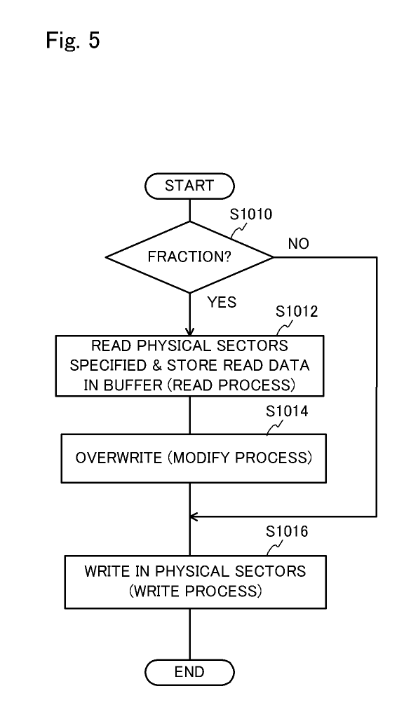

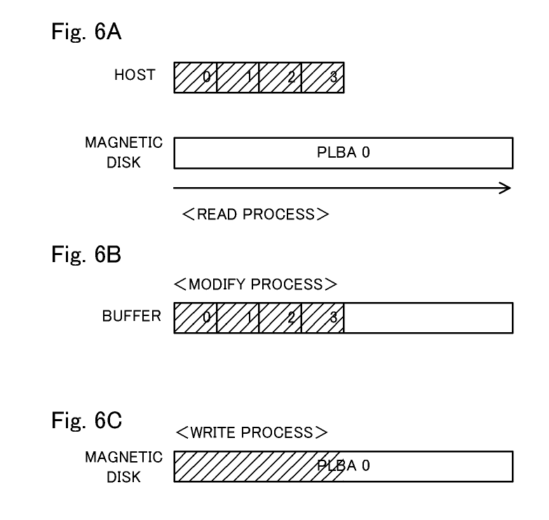

According to the first embodiment, when the size of the write data of the command supplied from the host computer 82 is smaller than the size of the physical sector of the magnetic disk 12, the priority order of the command is lowered. When there are commands having the lowered priority and the physical sectors thereof are close to each other (within the range of N sectors), the process of reading data from the physical sectors in which the data of the commands having the lowered priority should be written is continuously carried out over these physical sectors. It is thus possible to reduce the number of times that the seek operation is carried out. This advantage will now be described by referring to comparative examples illustrated in FIGS. 5 and 6A through 6C. FIG. 5 is a flow chart of a comparative example having the conventional read modify write process, and FIGS. 6A through 6C schematically illustrate the comparative example.

As illustrated in FIGS. 5 and 6A through 6C, in the comparative example, when it is determined, at step S101, that data supplied from the host computer has a fraction, the comparative example carries out, for each data (each command), a read process of step S1012 (see FIG. 6A), a modify process of step S1014 (see FIG. 6B) and a write process of step S1016 (see FIG. 6C). Thus, the read process is repeatedly carried out m times where m is equal to the number of commands separately needed to the read modify write process. In contrast, the first embodiment executes the continuous read process at step S22. It is thus possible to efficiently perform the read modify write process and efficiently carry out the recording control.

In the above description of the first embodiment, the commands are combined in the case where the physical sectors in which the data of low priority are written are located in the range of N sectors, and the read process in the read modify write process is continuously carried out by the combined commands. However, the present embodiment is limited to the above but may be varied. For example, commands may be combined even when physical sectors in which data of low priority are written are not in the range of N sectors, so that the read process in the read modify write process for the data can be carried out continuously.

The embodiment is not limited to the case where it is determined whether the continuous read process should be carried out on the basis of the number of sectors, but may be varied so as to employ another reference for determination. For example, it may be determined whether physical sectors in which data of low priority are written are in the range of an identical track. It may be determined whether physical sectors in which data of low priority are written are in the range of an adjacent track in addition to the identical track.

### Second Embodiment

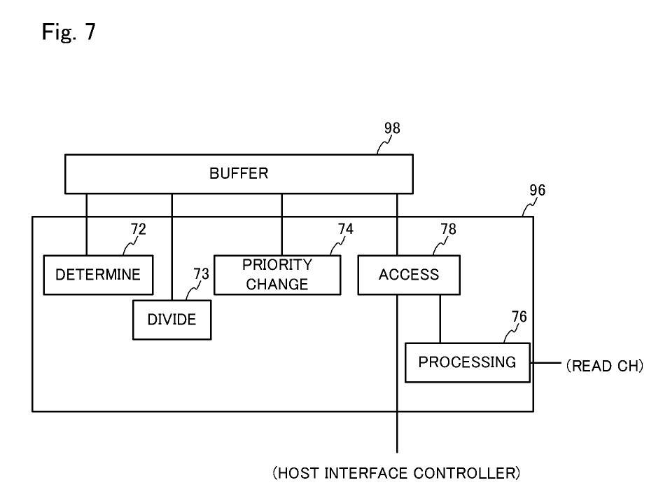

A description will now be given, with reference to FIGS. 7 through 9, of a second embodiment.

FIG. 7 is a block diagram of a structure of the buffer memory controller 96 used in the second embodiment. As illustrated in FIG. 7, the buffer memory controller 96 has a dividing part 73 in addition to the configuration of the buffer memory controller 96 employed in the first embodiment.

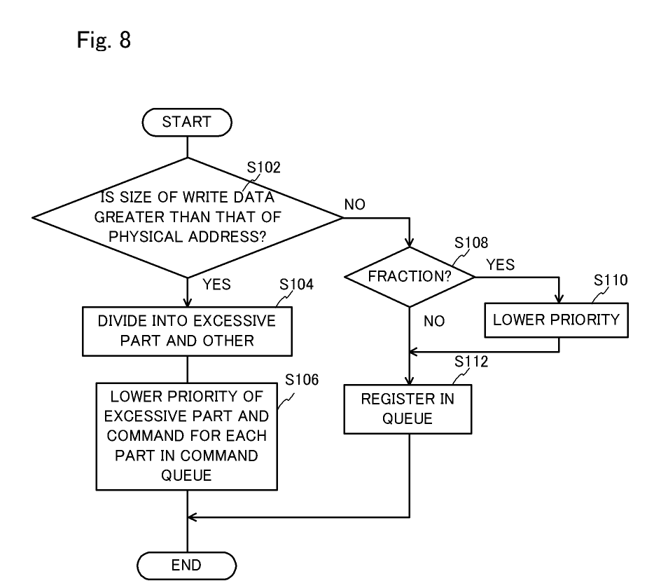

A description will now be given, with reference to FIGS. 8 through 10, of a process of writing data in the magnetic disk 12 while focusing on the buffer memory controller 96 illustrated in FIG. 7.

First, a process of queuing write data stored in the buffer memory 98 will now be described with reference to FIG. 8. The process illustrated in FIG. 8 assumes the following. A write request (command) is issued to the host interface controller 94 by the host computer 82. Write data is transferred from the host computer 82 and is written in the buffer memory 98.

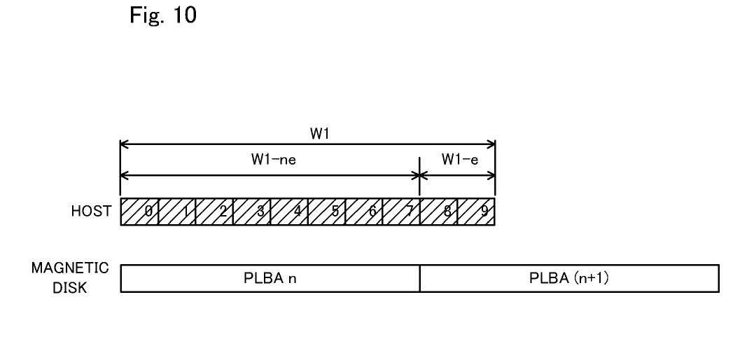

At step S102 illustrated in FIG. 8, the determining part 72 of the buffer memory controller 96 compares the size of the write data stored in the buffer memory 98 with the size of the physical sector of the magnetic disk 12, and determines whether the size of the write data is greater than that of the physical sector (4096 bytes) of the write disk 12. For example, FIG. 10A shows a case where the size of write data W1 (5120 bytes) is greater than that of physical sector PLBAn (4096 bytes) of the magnetic disk 12. In such a case, the answer of step S102 is YES.

At subsequent step S104, the dividing part 73 divides write data W1 into a part W1-e that exceeds the size of the physical sector and another part W1-ne equal in size to the physical sector. The part W1-e may be referred to as excessive part or fraction part. The excessive part W1-e needs the read modify write process, and the remaining W1-ne does not need the read modify write process. The command is divided into two commands respectively associated with the data part W1-ne and the data part W1-e.

At step S106, the dividing part 73 queues the commands related to the data parts W1-e and W1-ne. In this queuing, the dividing part 73 lowers the priority of the data part W1-e.

When the answer of step S102 is NO, at step S108, the determining part 72 determines whether the write data has a fraction, that is, whether the size of the write data is smaller than that of the physical sector of the magnetic disk 12. When the answer of step S108 is YES, the process proceeds to step S110 at which the order changing part 74 lowers the priority of the write data (command). At subsequent step S112, the determining part 72 queues the write data (command). When the answer of step S108 is NO, the determining part 72 queues the write data without lowering the priority.

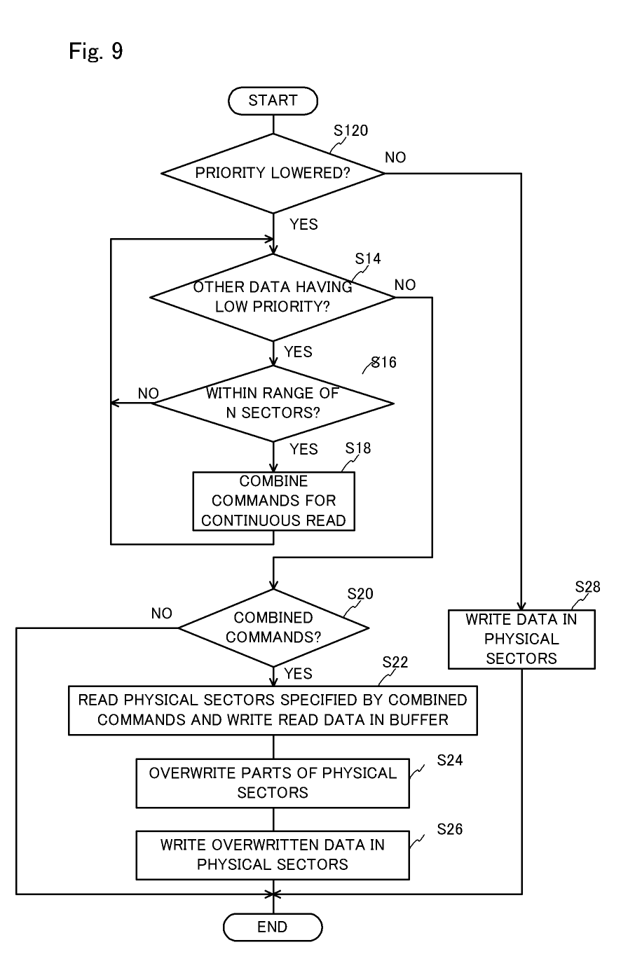

Further, according to the present embodiment, in parallel with the above-described queuing, a write process illustrated in FIG. 9 is executed. At step S120, the determining part 72 refers to the first command among the queued commands, and determines whether this command is a command having lowered priority. When the answer of step S120 is YES, the process of steps S14-S26 is executed in the same manner as that in the first embodiment. In this process, the read process for physical sectors in which modified data should be written is continuously carried out when there are multiple parts that need the read modify write process (within the range of N sectors). It is thus possible to realize the efficient read modify write process.

When the answer of step S120 is NO, at step S28, the data are written in the physical sector without any modification.

According to the second embodiment, it is possible to realize the efficient read modify write process like the first embodiment and to further improve the efficiency by lowering the priority of only a data part necessary for the read modify write process when write data of a size greater than that of the physical sector is supplied from the host computer.

### Third Embodiment

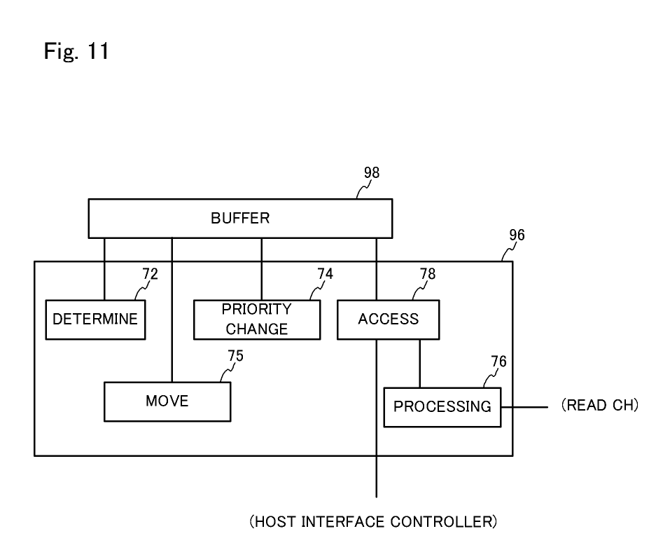

A third embodiment will now be described with reference to FIGS. 11 through 13B. The third embodiment executes a process for efficiently utilizing the area of the buffer memory 98.

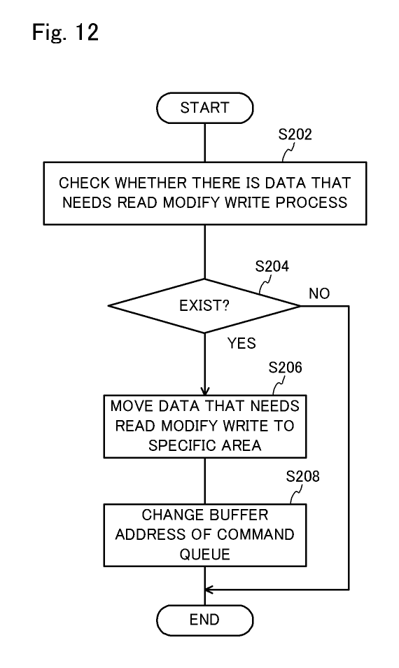

As illustrated in FIG. 11, the buffer memory controller 96 has a moving part 75 in addition to the configuration employed in the first embodiment illustrated in FIG. 3. The buffer memory controller 96 (mainly the moving part 75) executes a process illustrated in FIG. 12 in addition to the processes executed in the first and second embodiments.

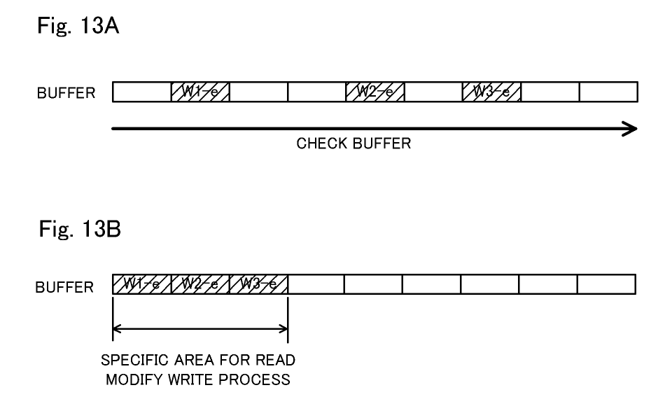

The flowchart of FIG. 12 commences with step S202 at which the accessing part 78 accesses the buffer memory 98 and checks whether there is data that needs the read modify write process in the buffer memory 98. In this checking, as illustrated in FIG. 13A, if there are data W1-e, W2-e, and W3-e that need the read modify write process, the answer of step S204 is YES.

At subsequent step S206, the moving part 75 moves the data W1-e, W2-e and W3-e that needs the read modify write process to a specific area dedicated to the read-modify-write process. As illustrated in FIG. 13B, the read-modify-write dedicated area is a continuous area defined in a part of the buffer memory 98.

At step S208, in association with the movement of the data to the read-modify-write dedicated area, the accessing part 78 or the MPU 84 illustrated in FIG. 1 changes the buffer address of the command queue.

When it is determined, at step S202, that there is no data that needs the read modify write process and the answer of step S204 is thus NO, the process illustrated in FIG. 12 is terminated.

According to the third embodiment, the moving part 75 moves the data that needs the read modify write process to the continuous area of the buffer memory 98, there is no possibility that data that needs the read modify write process may be intermittently stored in the buffer memory 98. It is thus possible to secure the continuous buffer area for subsequent data, as illustrated in FIG. 13B and to efficiently utilize the buffer memory 98.

### Fourth Embodiment

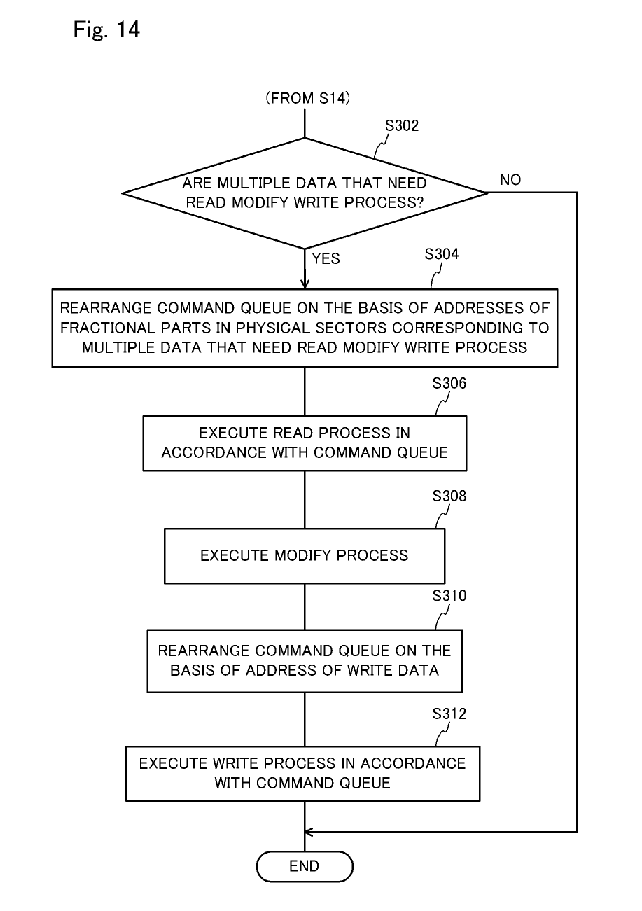

A fourth embodiment will now be described with reference to FIG. 14. The fourth embodiment executes a process illustrated in FIG. 14 instead of steps S20 through S26 illustrated in FIGS. 3 and 9.

At step S14 in FIGS. 3 and 9, it is determined that there is no data of the lowered priority, the process proceeds to step S302, at which the determining part determines whether there are multiple data that need the read modify write process. When the answer of step S302 is YES, the process proceeds to step S304 at which the accessing part 78 rearranges the command queue on the basis of the addresses of fractional sectors in the physical sectors corresponding to the multiple data that need the read modify write process. The fractional sectors are sections that are in the physical sector and are free of write data.

At step S306, the processing part 76 executes the read process in the read modify write process in accordance with the command queue. This read process differs from that in the first through third embodiments in that only the fractional sectors are read. That is, the overall physical sector is not read.

At step S308, the processing part 76 executes the modify process. At subsequent step S310, the processing part 76 rearranges the command queue on the basis of the leading address of the write data (obtained by combining data to be written and the fractional sectors). At step S312, the processing part 76 executes the write process in accordance with the rearranged command queue obtained at step S310.

According to the fourth embodiment, the command queue is rearranged on the basis of the addresses of the fractional sectors prior to the read process, and is rearranged on the basis of the address of data to be written prior to the write process. It is thus possible to execute the read process and the write process at the minimum movement distance (seek distance) regardless of whether the fractional sectors are located in a front portion of the physical sector or a rear portion thereof and to thus realize highly efficient read modify write process.

The fourth embodiment is not limited to the configuration in which only the fractional sectors are read but may include another configuration in sectors leading to and lagging behind the fractional sectors of concern.

### Fifth Embodiment

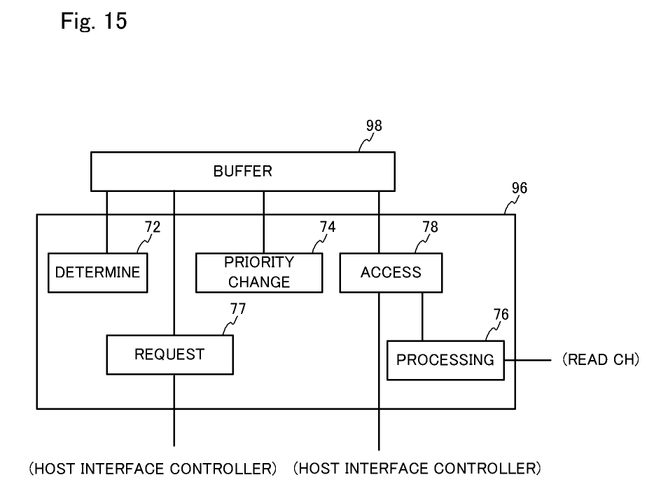

A fifth embodiment will now be described with reference to FIGS. 15 through 18.

As illustrated in FIG. 15, the buffer memory controller 96 of the fifth embodiment is equipped with a request part 77 in addition to the configuration employed in the first embodiment (FIG. 3).

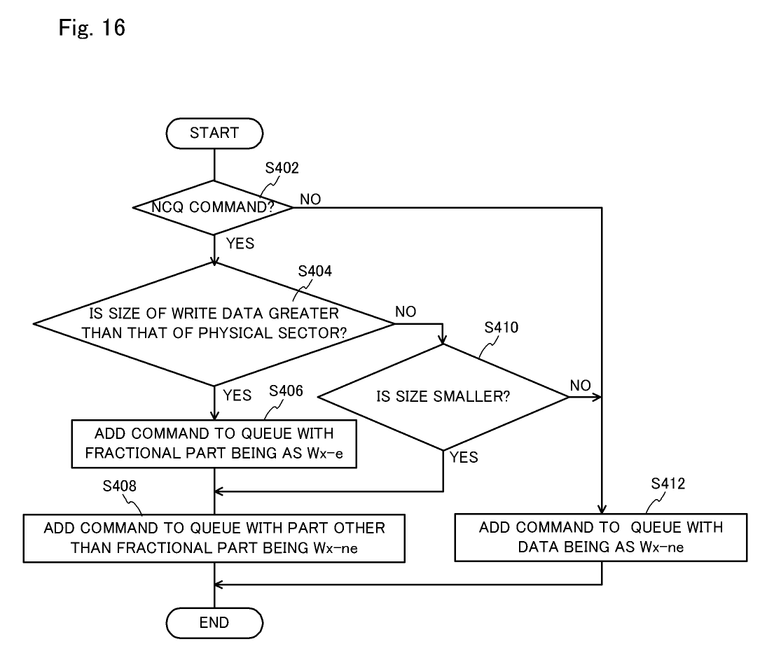

FIG. 16 is a flowchart of command queuing employed in the fifth embodiment. At step S402, the determining part 72 determines whether the command received from the host computer 82 is a native command queuing (NCQ) command. When the answer of step S402 is YES, the determining part 72 determines whether the size of the write data exceeds the size of the physical sector at step S404. When the answer of step S404 is YES, the process proceeds to step S406 at which the determining part 72 assumes the excessive (fractional) part as Wx-e (x is a natural number), and adds the command for the fractional part to the command queue. At step S408, the determining part 72 assumes the part other than the fractional part as Wx-ne, and adds the command for this part to the command queue.

When the answer of step S404 is NO, the process proceeds to step S410 at which the determining part 72 determines whether the size of the write data is smaller than that of the physical sector. When the answer of step S410 is YES, the determining part 72 assumes the write data as Wx-e and adds the command for the write data to the command queue at step S408. When the answer of step S410 is NO, the determining part 72 assumes the write data as Wx-ne and adds the command for the write data to the command queue at step S412.

When the answer of step S402 is NO, the determining part 72 assumes the write data as Wx-ne, and adds the command for the write data to the command queue. The reason why the write data is assumed as Wx-ne for commands other than the NCQ command is that the commands other than the NCQ command are not allowed to divide data and receive divided data and to be handled in the same manner as that for the NCQ command.

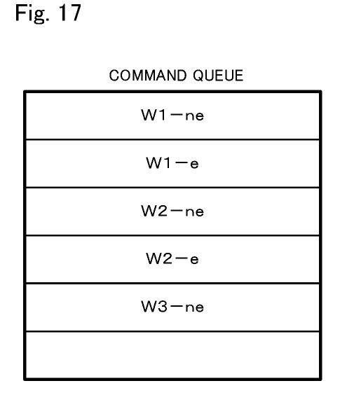

FIG. 17 illustrates an example of the command queue obtained through the above-described process. In FIG. 17, W1-ne and W2-ne are commands queued through step S408, and W1-e and W2-e are commands queued through step S406. Further, W3-ne is a command queued through step S412.

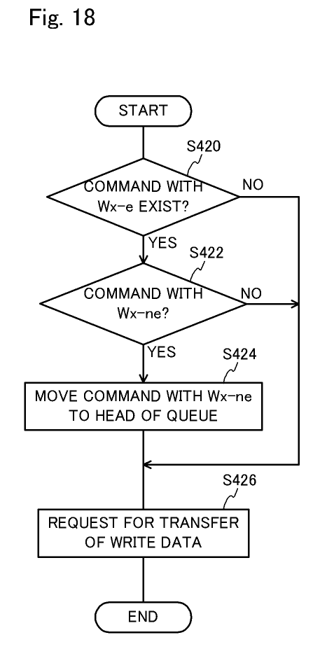

A description will now be given, with reference to FIG. 18 of a process executed when the buffer memory controller 96 requests the host computer 82 to send write data.

At step S420 in FIG. 18, the determining part 72 determines whether there is a command involved in data Wx-e in the command queue. When the answer of step S420 is YES, the process proceeds to step S422, at which the determining part 72 determines whether there is a command involved in data Wx-ne. When the answer of step S422 is YES, the process proceeds to step S424, at which the order changing part 74 moves the command involved in data Wx-ne to the head of the command queue. That is, when there are a command involved in data Wx-e and a command involved in data Wx-ne, the command involved in data Wx-ne that is not needed to the read modify write process is moved to the head of the command queue in order to preferentially handle the command involved in the data Wx-ne. At step S426, the request part 77 requests the host computer 82 to send data in response to the command located at the head of the command queue.

When the answer of either step S420 or S422 is NO, the request part 77 requests the host computer 82 to send data without rearranging the command queue. More particularly, the host computer 82 is requested to send data when there is only a command involved in data Wx-e that is not needed to perform the read modify write process or when there is only a command involved in data Wx-ne that is needed to perform the read modify write process.

According to the fifth embodiment, the request for sending data that is not needed to perform the read modify write process is preferentially handled. Thus, the data that is not needed to perform the read modify write process is preferentially written in the magnetic disk 12 and the request for sending data needed to perform the read modify write process is issued later at a time. It is thus possible to reduce the quantity of data simultaneously stored in the buffer memory 98 and to efficiently utilize the buffer memory 98.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A storage control method comprising:
determining whether a size of write data specified by a command supplied from a host is smaller than a size of a physical sector of a recording medium;
lowering priority of the write data when the size of the write data is smaller than the size of the physical sector;
continuously reading, when a plurality of commands for write data having lowered priority are supplied, data in physical sectors specified in the plurality of commands; and
executing a modify write process on the basis of a result of continuously reading the data.

2. The storage control method according to claim 1, further comprising:
dividing the write data into first data equal in length to the physical sector and second data other than the first data when the size of the write data specified by the command supplied from the host is greater than that of the physical sector of the recording medium; and
dividing the command into a first command related to the first data and a second command related to the second data,
wherein the determining includes determining whether a size of the second data is smaller than that of the physical sector.

3. The storage control method according to claim 1, further comprising moving the write data having the priority lowered by the lowering to a continuous buffer area.

4. The storage control method according to claim 1, wherein the continuously reading includes continuously reading only parts in the physical sector that are free of data, and the executing the modify write process performs a write process in a different order of execution from that of the continuously reading.

5. The storage control method according to claim 1, further comprising:
preferentially requesting the host to send data that does not need the continuously reading and the executing the modify write process when the command supplied from the host is a native command queuing command; and
requesting the host to continuously send data necessary for the continuous reading and the executing the modify write process.

6. A storage control unit comprising:
a first part that determines whether a size of write data specified by a command supplied from a host is smaller than a size of a physical sector of a recording medium;
a second part that lowers priority of the write data when the size of the write data is smaller than the size of the physical sector;
a third part that continuously reads, when a plurality of commands for write data having lowered priority are supplied, data in physical sectors specified in the plurality of commands; and
a fourth part that executes a modify write process on the basis of a result of continuously reading the data.

7. The storage control unit according to claim 6, further comprising:
a fifth part that divides the write data into first data equal in length to the physical sector and second data other than the first data when the size of the write data specified by the command supplied from the host is greater than that of the physical sector of the recording medium; and
a sixth part that divides the command into a first command related to the first data and a second command related to the second data,
wherein the first part determines whether a size of the second data is smaller than that of the physical sector.

8. The storage control unit according to claim 6, further comprising a part that moves the write data having the priority lowered by the second part to a continuous buffer area.

9. The storage control unit according to claim 6, wherein the third part includes a part that continuously reads only parts in the physical sector that are free of data, and the fourth path performs a write process in a different order of execution from that of the third part.

10. A storage apparatus comprising:
a storage control unit; and
a recording medium,
the storage control unit including:
a first part that determines whether a size of write data specified by a command supplied from a host is smaller than a size of a physical sector of the recording medium;
a second part that lowers priority of the write data when the size of the write data is smaller than the size of the physical sector;
a third part that continuously reads, when a plurality of commands for write data having lowered priority are supplied, data in physical sectors specified in the plurality of commands; and
a fourth part that executes a modify write process on the basis of a result of continuously reading the data.
